(19) United States
(12) Patent Application Publication
(10) Pub. No.: US 2021/0312261 A1
(43) Pub. Date: Oct. 7, 2021

(54) NEURAL NETWORK SEARCH METHOD AND RELATED APPARATUS

(71) Applicant: HUAWEI TECHNOLOGIES CO., LTD., Shenzhen (CN)

(72) Inventors: Yixing XU, Beijing (CN); Kai HAN, Beijing (CN); Yunhe WANG, Beijing (CN); Chunjing XU, Shenzhen (CN); Qi TIAN, Shenzhen (CN)

(21) Appl. No.: 17/220,158

(22) Filed: Apr. 1, 2021

(30) Foreign Application Priority Data
Apr. 2, 2020 (CN) 202010257790.7

(51) Int. Cl. G06N 3/04; G06N 3/08

(52) U.S. Cl. CPC G06N 3/0454; G06N 3/08

(57) ABSTRACT

The present application discloses a neural network search method in the field of artificial intelligence, and the neural network search method includes: obtaining a feature tensor of each of a plurality of neural networks, where the feature tensor of each neural network is used to represent a computing capability of the neural network; inputting the feature tensor of each of the plurality of neural networks into an accuracy prediction model for calculation, to obtain accuracy of each neural network, where the accuracy prediction model is obtained through training based on a ranking-based loss function; and determining a neural network corresponding to the maximum accuracy as a target neural network. Embodiments of the present invention help improve accuracy of a network structure found through search.

### CROSS-REFERENCE TO RELATED APPLICATION

This application claims priority to Chinese Patent Application No. 202010257790.7, filed on Apr. 2, 2020, which is hereby incorporated by reference in its entirety.

### TECHNICAL FIELD

The present application relates to the field of artificial intelligence, and in particular, to a neural network search method and a related apparatus.

### BACKGROUND

Artificial intelligence (AI) is a theory, a method, a technology, and an application system that simulate, extend, and expand human intelligence by using a digital computer or a machine controlled by a digital computer, sense the environment, acquire knowledge, and use the acquired knowledge to obtain a best result. In other words, artificial intelligence is a branch of computer science, and is intended to understand the essence of human intelligence and produce an intelligent machine that can react in a manner similar to human intelligence. Artificial intelligence is to study design principles and implementation methods of various intelligent machines, to enable the machines to have sensing, reasoning, and decision-making functions. Research in the field of artificial intelligence includes robotics, natural language processing, computer vision, decision-making and reasoning, human-computer interaction, recommendation and search, AI basic theory, and the like.

A convolutional neural network (CNN) is widely used in the field of computer vision, and successfully applied to a plurality of practical applications such as image classification, target detection, and semantic segmentation. However, the success of CNN relies heavily on a neural network structure manually designed by experts. Therefore, methods that can automatically design a neural network structure based on different tasks has become a focus of AI research. A neural network architecture search (NAS) technology is an example of such method.

The NAS technology is mainly divided into two aspects: one is to design a search space, and the other is to design a search algorithm. Designing a search space is performed based on existing operators. For example, a 10-layer neural network is given, an operation at each layer may be selected from three types: a convolution operation, a pooling operation, and a full connection operation. In this way, 3¹⁰=59049 different network structures are constituted, and the network structures constitute a fixed search space. Designing of a search algorithm involves how to efficiently find out a neural network structure having good performance for a specific task within a given search space.

However, it is usually time-consuming to determine whether a neural network structure has good performance. For example, training a ResNet50 network to convergence (for example, training 200 epochs) on an ImageNet dataset usually takes several days. Therefore, in an existing NAS technology, usually, after a network is given, a small quantity of epochs are trained on a subset of a dataset, and an intermediate result is used as an alternative of final performance of the network structure. However, the alternative method has a problem that the intermediate result of the network structure is usually not in a linear relationship with a final result of the network structure. Therefore, the alternative method changes the ranking of structures. For example, a structure that originally has a good final result but has a poor intermediate result is discarded during a selection process. Some research papers show that performance of the existing NAS search algorithm is not as good as the result obtained by random searching.

### SUMMARY

Embodiments of the present application provide a neural network search method and a related apparatus. The embodiments of the present application help improve accuracy of a network structure found through search.

According to a first aspect, an embodiment of the present application provides a neural network search method, including:

obtaining a feature tensor of each of a plurality of neural networks, where the feature tensor of each neural network is used to represent a computing capability of the neural network; inputting the feature tensor of each of the plurality of neural networks into an accuracy prediction model for calculation, to obtain accuracy of the neural network, where the accuracy prediction model is obtained through training based on a ranking-based loss function; and determining a neural network corresponding to maximum accuracy as a target neural network.

The accuracy of the neural networks is predicted by using the accuracy prediction model obtained through the ranking-based loss function, and the target neural network is determined based on the accuracy, so that accuracy of a neural network found through search is higher than the accuracy of a neural network found through search in the prior art.

The accuracy of the neural network is an evaluation standard of a processing result of performing task processing by using the network. For example, when a neural network is used to perform image classification, the accuracy of the neural network is the accuracy rate of the image classification. For another example, when a neural network is used to perform image detection, the accuracy of the neural network is the mean average accuracy of the image detection. For still another example, when a neural network is used to perform image segmentation, the accuracy of the neural network is the mean intersection-over-union rate of the image segmentation.

In a feasible embodiment, the ranking-based loss function is a first loss function, and the first loss function is used to measure a relationship between ranking of the accuracy that is of the neural networks and that is predicted by the accuracy prediction model and ranking of real accuracy of the neural networks.

A larger difference between the ranking of the accuracy of the neural networks predicted based on the accuracy prediction model and the ranking of the real accuracy of the neural networks accuracy indicates a larger loss value obtained based on the first loss function, and a smaller difference between the ranking of the accuracy of the neural networks predicted based on the accuracy prediction model between the ranking of the real accuracy of the neural networks indicates a smaller loss value obtained based on the first loss function. Therefore, a case in which ranking of predicted model accuracy is inconsistent with ranking of real model accuracy is punished, so that ranking of predicted accuracy output by a trained model is hopefully consistent with real ranking as much as possible.

Further, the first loss function is:

[symbol]

₁(W)=Σᵢ₌₁ⁿ⁻¹Σⱼ₌ᵢ₊₁ⁿφ((ε(Nᵢ)−ε(Nⱼ))*sign(yᵢ−yⱼ)).

Here Nᵢ and Nⱼ are respectively an i^{th} neural network and a j^{th} neural network that are used when training a model, ε(Nᵢ) and ε(Nⱼ) are respectively accuracy obtained through calculation by inputting Nᵢ and Nⱼ into the prediction model, and yᵢ and yⱼ are respectively real accuracy of Nᵢ and Nⱼ.

φ(z)=(1−z)₊ is a hinge function. A pair of data is given, the loss function is zero only if accuracy of the pair of data is ranked correctly and a difference between the accuracy is large enough. φ(z) may be another monotonically non-increasing function, for example, a logistic function φ(z)=log (1+e^{-z}) or an exponential function φ(z)=e^{-z}.

In a feasible embodiment, the ranking-based loss function is obtained by performing a linear combination on the first loss function and a second loss function.

The first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

When a distance between two neural networks with similar accuracy in the feature space is longer, or a distance between two neural networks with different accuracy in the feature space is shorter, a loss value obtained based on the second loss function is larger. Alternatively, when a distance between two neural networks with similar accuracy in the feature space is shorter, or a distance between two neural networks with different accuracy in the feature space is longer, a loss value obtained based on the second loss function is smaller, thereby assigning continuity to a feature.

Further, the ranking-based loss function is:

[symbol]

= [symbol] ₁+λ [symbol] ₂.

Here λ is a constant, [symbol] ₁ is a first loss function, [symbol] ₂ is a second loss function, and the first loss function [symbol] ₁ is:

[symbol]

(W)=Σᵢ₌₁ⁿ⁻¹Σⱼ₌ᵢ₊₁ⁿφ((ε(Nᵢ)−ε(Nⱼ))*sign(yᵢ−yⱼ)).

Here Nᵢ and Nⱼ are respectively an i^{th} neural network and a j^{th} neural network that are used when training a model, ε(Nᵢ) and ε(Nⱼ) are respectively accuracy obtained through calculation by inputting Nᵢ and Nⱼ into the prediction model, and yᵢ and yⱼ are respectively real accuracy of Nᵢ and Nⱼ.

φ(z)=(1−z)₊ is a hinge function. A pair of data is given, the loss function is zero only if accuracy of the pair of data is ranked correctly and a difference between the accuracy is large enough. φ(z) may be another monotonically non-increasing function, for example, a logistic function φ(z)=log (1+e^{-z}) or an exponential function φ(z)=e^{-z}.

The second loss function [symbol] ₂ is:

[symbol]

₂(W)=Σᵢ₌₁ⁿ⁻²Σⱼ₌ᵢ₊₁ⁿ⁻¹Σₖ₌ⱼ₊₁ⁿφ((dᵢⱼ−dᵢₖ)*sign(lᵢⱼ−lᵢₖ)).

Here dᵢⱼ=∥\tilde{ε}(Nᵢ)−\tilde{ε}(Nⱼ)∥₂, a difference between accuracy of two network structures may be represented as lᵢⱼ=|yᵢ−yⱼ|, where \tilde{ε}(Nᵢ) and \tilde{ε}(Nⱼ) are respectively features input into a last fully-connected layer in a prediction model after Nᵢ and Nⱼ are input into the prediction model.

In a feasible embodiment, the obtaining a feature tensor of each of a plurality of neural networks includes:

obtaining a directed acyclic graph of each unit of each of the plurality of neural networks; obtaining, based on the directed acyclic graph of each unit in each neural network, an adjacency matrix, a type vector, a runtime vector, and a parameter vector that correspond to each unit in each neural network, where the runtime vector is related to a hardware resource; determining a type matrix, a runtime matrix, and a parameter matrix of each unit based on the adjacency matrix, the type vector, the runtime vector, and the parameter vector of each unit in each neural network; and determining the tensor feature of each neural network based on the type matrix, the runtime matrix, and the parameter matrix of the unit in each neural network.

The tensor feature constituted by the type matrix, the runtime matrix, and the parameter matrix of the unit in the neural network is used to represent a computing capability of the neural network, so that computing capabilities of neural networks with different network structures can be well reflected, and accuracy of a neural network found through search can be significantly improved.

It should be noted that an element in the runtime vector of each unit is a time required for performing, on hardware, an operation, for example, 3×3 convolution or 1×1 convolution, in the unit. For example, if a unit includes the 3×3 convolution, 3×3 pooling, the 1×1 convolution, and 1×1 pooling, a runtime vector corresponding to the unit includes four elements, respectively corresponding to times required for performing the 3×3 convolution, the 3×3 pooling, the 1×1 convolution, and the 1×1 pooling on the hardware.

In addition, it should be noted that a size of the element in the runtime vector is related to a hardware resource and a calculation amount required for an operation in the unit. When the hardware resource is larger, the calculation amount required for the operation in the unit is smaller, and an element in a corresponding runtime is smaller.

In a feasible embodiment, before the inputting the feature tensor of each of the plurality of neural networks into an accuracy prediction model for calculation, to obtain accuracy of the neural network, the method further includes:

obtaining the accuracy prediction model, where the obtaining the accuracy prediction model includes:

obtaining training data and an initial prediction model, where the training data includes feature tensors of the plurality of neural networks and real accuracy corresponding to the neural networks; inputting the feature tensors of the plurality of neural networks into the initial prediction model for calculation, to obtain a plurality of pieces of prediction accuracy; obtaining the loss value through calculation based on the plurality of pieces of prediction accuracy, a plurality of pieces of real accuracy, and the ranking-based loss function; and adjusting a parameter in the initial prediction model based on the loss value, to obtain the accuracy prediction model.

In a feasible embodiment, before the inputting the feature tensor of each of the plurality of neural networks into an accuracy prediction model for calculation, to obtain accuracy of the neural network, the method further includes:

obtaining the accuracy prediction model from a training device.

According to a second aspect, an embodiment of the present application further provides an accuracy prediction model training method, including:

obtaining training data and an initial prediction model, where the training data includes feature tensors of a plurality of neural networks and real accuracy corresponding to the neural networks; inputting the feature tensors of the plurality of neural networks into the initial prediction model for calculation, to obtain a plurality of pieces of prediction accuracy; obtaining a loss value through calculation based on the plurality of pieces of prediction accuracy, a plurality of pieces of real accuracy, and a ranking-based loss function; and adjusting a parameter in the initial prediction model based on the loss value, to obtain the accuracy prediction model.

In a feasible embodiment, the ranking-based loss function is a first loss function, and the first loss function is used to measure a relationship between ranking of the accuracy that is of the neural networks and that is predicted by the accuracy prediction model and ranking of real accuracy of the neural networks.

A larger difference between the ranking of the accuracy that is of the neural networks and that is predicted based on the accuracy prediction model between the ranking of the real accuracy of the neural networks indicates a larger loss value obtained based on the first loss function; or a smaller difference between the ranking of the accuracy that is of the neural networks and that is predicted based on the accuracy prediction model and the ranking of the real accuracy of the neural networks indicates a smaller loss value obtained based on the first loss function.

Further, the first loss function is:

[symbol]

₁(W)=Σᵢ₌₁ⁿ⁻¹Σⱼ₌ᵢ₊₁ⁿφ((ε(Nᵢ)−ε(Nⱼ))*sign(yᵢ−yⱼ)),

where Nᵢ and Nⱼ are respectively an i^{th} neural network and a j^{th} neural network that are used when training a model, ε(Nᵢ) and ε(Nⱼ) are respectively accuracy obtained through calculation by inputting Nᵢ and Nⱼ into the prediction model, and yᵢ and yⱼ are respectively real accuracy of Nᵢ and Nⱼ.

φ(z)=(1−z)₊ is a hinge function. A pair of data is given, the loss function is zero only if accuracy of the pair of data is ranked correctly and a difference between the accuracy is large enough. φ(z) may be another monotonically non-increasing function, for example, a logistic function φ(z)=log (1+e^{-z}) or an exponential function φ(z)=e^{-z}.

In a feasible embodiment, the ranking-based loss function is obtained by performing a linear combination on the first loss function and a second loss function.

The first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

Further, the ranking-based loss function is:

[symbol]

= [symbol] ₁+λ [symbol] ₂,

where λ is a constant, [symbol] ₁ is a first loss function, [symbol] ₂ is a second loss function, and the first loss function [symbol] ₁ is:

[symbol]

₁(W)=Σᵢ₌₁ⁿ⁻¹Σⱼ₌ᵢ₊₁ⁿφ((ε(Nᵢ)−ε(Nⱼ))*sign(yᵢ−yⱼ)),

where Nᵢ and Nⱼ are respectively an i^{th} neural network and a j^{th} neural network that are used when training a model, ε(Nᵢ) and ε(Nⱼ) are respectively accuracy obtained through calculation by inputting Nᵢ and Nⱼ into the prediction model, and yᵢ and yⱼ are respectively real accuracy of Nᵢ and Nⱼ.

φ(z)=(1−z)₊ is a hinge function. A pair of data is given, the loss function is zero only if accuracy of the pair of data is ranked correctly and a difference between the accuracy is large enough. φ(z) may be another monotonically non-increasing function, for example, a logistic function φ(z)=log (1+e^{-z}) or an exponential function φ(z)=e^{-z}.

The second loss function [symbol] ₂ is:

[symbol]

₂(W)=Σᵢ₌₁ⁿ⁻²Σⱼ₌ᵢ₊₁ⁿ⁻¹Σₖ₌ⱼ₊₁ⁿφ((dᵢⱼ−dᵢₖ)*sign(lᵢⱼ−lᵢₖ)),

where dᵢⱼ=∥\tilde{ε}(Nᵢ)−\tilde{ε}(Nⱼ)∥₂, a difference between accuracy of two network structures may be represented as lᵢᵢ=|yᵢ−yⱼ|, where \tilde{ε}(Nᵢ) and \tilde{ε}(Nⱼ) are respectively features input into a last fully-connected layer in a prediction model after Nᵢ and Nⱼ are input into the prediction model.

According to a third aspect, an embodiment of the present application provides a neural network predictor, including:

an obtaining unit, configured to obtain a feature tensor of each of a plurality of neural networks, where the feature tensor of each neural network is used to represent a computing capability of the neural network;

a calculating unit, configured to input the feature tensor of each of the plurality of neural networks into an accuracy prediction model for calculation, to obtain accuracy of the neural network, where the accuracy of the neural network is an evaluation standard of a processing result obtained by performing task processing by using the neural network, the accuracy prediction model is obtained through training based on a ranking-based loss function; and

a determining unit, configured to determine a neural network corresponding to maximum accuracy as a target neural network.

In a feasible embodiment, the ranking-based loss function is a first loss function, and the first loss function is used to measure a relationship between ranking of the accuracy that is of the neural networks and that is predicted by the accuracy prediction model and ranking of real accuracy of the neural networks.

A larger difference between the ranking of the accuracy that is of the neural networks and that is predicted based on the accuracy prediction model and the ranking of the real accuracy of the neural networks indicates a larger loss value obtained based on the first loss function; or a smaller difference between the ranking of the accuracy that is of the neural networks and that is predicted based on the accuracy prediction model and the ranking of the real accuracy of the neural networks indicates a smaller loss value obtained based on the first loss function.

In a feasible embodiment, the ranking-based loss function is obtained by performing a linear combination on the first loss function and a second loss function.

The first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

In a feasible embodiment, the obtaining unit is configured to:

obtain a directed acyclic graph of each unit of each of the plurality of neural networks; obtain, based on the directed acyclic graph of each unit in each neural network, an adjacency matrix, a type vector, a runtime vector, and a parameter vector that correspond to each unit in each neural network, where the runtime vector is related to a hardware resource; determine a type matrix, a runtime matrix, and a parameter matrix of each unit based on the adjacency matrix, the type vector, the runtime vector, and the parameter vector of each unit in each neural network; and determine the tensor feature of each neural network based on the type matrix, the runtime matrix, and the parameter matrix of the unit in each neural network.

In a feasible embodiment, the obtaining unit is further configured to:

before the calculating unit inputs the feature tensor of each of the plurality of neural networks into the accuracy prediction model for calculation, to obtain the accuracy of the neural networks, obtain the accuracy prediction model.

In an aspect of obtaining the accuracy prediction model, the obtaining unit is configured to:

obtain training data and an initial prediction model, where the training data includes feature tensors of the plurality of neural networks and real accuracy corresponding to the neural networks; input the feature tensors of the plurality of neural networks into the initial prediction model for calculation, to obtain a plurality of pieces of prediction accuracy; obtain the loss value through calculation based on the plurality of pieces of prediction accuracy, a plurality of pieces of real accuracy, and a ranking-based loss function; and adjust a parameter in the initial prediction model based on the loss value, to obtain the accuracy prediction model.

In a feasible embodiment, the obtaining unit is further configured to:

before the calculating unit inputs the feature tensor of each of the plurality of neural networks into the accuracy prediction model for calculation, to obtain the accuracy of the neural networks, obtain the accuracy prediction model from a training device.

According to a fourth aspect, an embodiment of the present application provides a training device, including:

an obtaining unit, configured to obtain training data and an initial prediction model, where the training data includes feature tensors of a plurality of neural networks and real accuracy corresponding to the neural networks;

a calculating unit, configured to input the feature tensors of the plurality of neural networks into the initial prediction model for calculation, to obtain a plurality of pieces of prediction accuracy; and obtain a loss value through calculation based on the plurality of pieces of prediction accuracy, a plurality of pieces of real accuracy, and a ranking-based loss function; and

an adjusting unit, configured to adjust a parameter in the initial prediction model based on the loss value, to obtain the accuracy prediction model.

In a feasible embodiment, the ranking-based loss function is a first loss function, and the first loss function is used to measure a relationship between ranking of the accuracy that is of the neural networks and that is predicted by the accuracy prediction model and ranking of real accuracy of the neural networks.

A larger difference between the ranking of the accuracy that is of the neural networks and that is predicted based on the accuracy prediction model and the ranking of the real accuracy of the neural networks indicates a larger loss value obtained based on the first loss function; or a smaller difference between the ranking of the accuracy that is of the neural networks and that is predicted based on the accuracy prediction model and the ranking of the real accuracy of the neural networks indicates a smaller loss value obtained based on the first loss function.

In a feasible embodiment, the ranking-based loss function is obtained by performing a linear combination on the first loss function and a second loss function.

The first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

According to a fifth aspect, an embodiment of the present application provides a neural network predictor, including:

a processor and a memory coupled to the processor, where

the memory stores an instruction, and when executing the instruction stored in the memory, the processor is configured to perform a part or all of the method according to the first aspect.

According to a sixth aspect, an embodiment of the present application provides a training device, including:

a processor and a memory coupled to the processor, where

the memory stores an instruction, and when executing the instruction stored in the memory, the processor is configured to perform a part or all of the method according to the second aspect.

According to a seventh aspect, an embodiment of the present application provides a computer-readable storage medium, where the computer-readable storage medium stores a computer program, and when being executed by a processor, the computer program implements a part or all of the method according to the first aspect or the second aspect.

Such aspects or other aspects of the present application are explained in more details in the following descriptions.

### BRIEF DESCRIPTION OF DRAWINGS

To describe technical solutions in embodiments of the present application or in the prior art more clearly, the following briefly describes accompanying drawings required for describing the embodiments or the prior art. Apparently, the accompanying drawings in the following description show merely some embodiments of the present application, and a person of ordinary skill in the art may derive other drawings from the accompanying drawings without creative efforts.

FIG. 1 is a schematic diagram of an application framework of a neural network search method according to an embodiment of the present application;

FIG. 2 is a schematic diagram of a system architecture according to an embodiment of the present application;

FIG. 3 is a structural diagram of chip hardware according to an embodiment of the present application;

FIG. 4 is a schematic flowchart of a neural network search method according to an embodiment of the present application;

FIG. 5a, FIG. 5b, FIG. 5c, FIG. 5d, FIG. 5e, and FIG. 5f are a schematic diagram of a principle of obtaining a feature tensor according to an embodiment of the present application;

FIG. 6 is a schematic structural diagram of an accuracy prediction model according to an embodiment of the present application;

FIG. 7 is a schematic flowchart of a training method of an accuracy prediction model according to an embodiment of the present application;

FIG. 8 is a schematic structural diagram of a neural network predictor according to an embodiment of the present application;

FIG. 9 is a schematic structural diagram of a training device according to an embodiment of the present application;

FIG. 10 is a schematic structural diagram of another neural network predictor according to an embodiment of the present application; and

FIG. 11 is a schematic structural diagram of a training device according to an embodiment of the present application.

### DESCRIPTION OF EMBODIMENTS

The following describes embodiments of this application with reference to accompanying drawings.

To resolve the problem in the background, two solutions are mainly proposed in the prior art.

Solution 1:

S1: First, manually extract a feature from an original network structure. Specifically, operation type code, a size of an operation core, and a ratio between an input channel quantity and an output channel quantity, that are at each layer are used as features.

S2: Input the manual feature in S1 into a long short term memory (LSTM) unit, to obtain a learning feature.

S3: Input the learning feature in S2 into a multi-layer perceptron (MLP), and perform training by using a minimum mean square error MSE loss function, to obtain prediction accuracy.

Defects of the Solution 1:

(1) The method of manually extracting the feature is excessively limited and can only be applied to a network structure that does not have a shortcut and of which all layers are sequentially superimposed.

(2) The method of manually extracting the feature is too simple to express a computing capability of the network structure.

(3) A loss function of a model is a mean square error loss function, only an absolute accuracy value of a structure is concerned, and ranking of networks is not concerned.

Solution 2:

S1: Manually extract a feature from an original network structure.

Specifically, it is assumed that a network includes a dense convolution network block (DB), a residual block (RB), and a pooling block (PB), and the feature is extracted based on the three blocks.

S2: Input the manual feature in S1 into a random forest predictor to predict accuracy of the network structure.

S3: Embed the random forest predictor into an existing search algorithm.

Defects of the Solution 2:

(1) The method of manually extracting the feature is excessively limited and can only be applied to a network structure with only the DB, the RB, and the PB.

(2) The method of manually extracting the feature is too simple to express a computing capability of the network structure.

(3) A loss function of a model is a mean square error loss function, only an absolute accuracy value of a structure is concerned, and ranking of networks is not concerned.

Based on the foregoing defects in the prior art, the present application provides a ranking-based neural network search method. The following describes a specific implementation process of the method in detail.

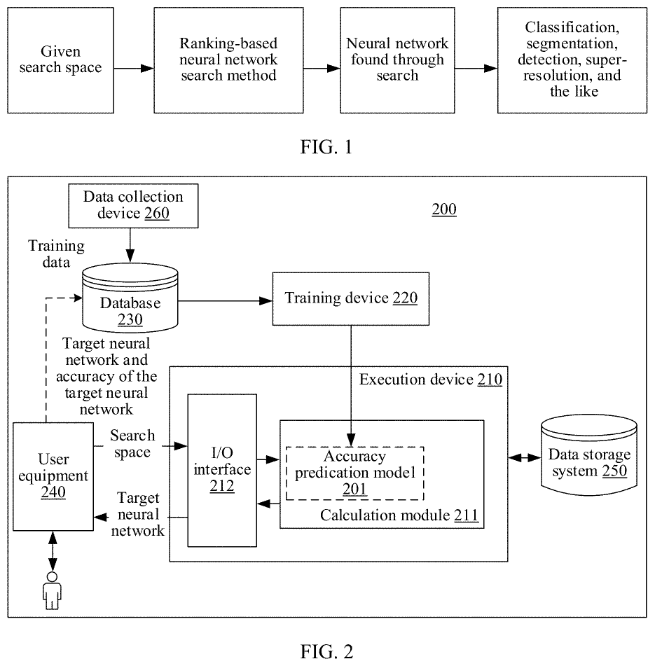

FIG. 1 is a schematic flowchart of a structure of a neural network according to an embodiment of the present application. As shown in FIG. 1, a target neural network is determined in a search space by using a ranking-based neural network search method. The target neural network is a neural network with best performance in the search space, for example, a neural network with a fastest calculation speed. Then the neural network is used to perform tasks such as classification, segmentation, detection, and super-resolution.

Specifically, a tensor feature of each neural network in the search space is obtained, the tensor feature of each neural network is input into an accuracy prediction model for calculation, to obtain accuracy of each neural network, and then a neural network with the maximum accuracy is determined as the target neural network. Finally, the target neural network is used to perform tasks such as classification, segmentation, detection, and super-resolution.

It should be noted herein that the foregoing tasks are usually performed by a CNN. Therefore, all neural networks in the foregoing search space are CNNs.

Referring to FIG. 2, an embodiment of the present application provides a system architecture 200, including a data collection device 260 and a training device 220, where the data collection device 260 is configured to collect training data and store the training data in a database 230, and the training data includes a tensor feature of a neural network and accuracy of the neural network; and the training device 220 is configured to generate an accuracy prediction model 201 through training based on the training data maintained in the database 230. The following describes in more detail how the training device 220 obtains the accuracy prediction model 201 based on the training data, and obtains the accuracy of the neural network based on the accuracy prediction model 201.

Working of each layer in a deep neural network may be described by using a mathematical expression \vec{y}=a(W·\vec{x}+\vec{b}). From a physical perspective, the working of each layer in the deep neural network may be understood as completing transformation from an input space to an output space (that is, from a row space to a column space of a matrix) by performing five operations on the input space (a set of input vectors). The five operations include: 1. dimension increasement/dimension reduction; 2. zooming in/zooming out; 3. rotation; 4. translation; and 5. “bending”. The operations of 1, 2, and 3 are performed by W·\vec{x}, the operation of 4 is performed by +\vec{b}, and the operation of 5 is performed by a( ). A reason why the word “space” is used herein for description is that a classified object is not a single object, but a type of object. The space refers to a set of all individuals of this type of object. W is a weight vector, with each value in the vector representing a weight value of a neuron in the neural network at the layer. The weight vector W determines the space transformation from the input space to the output space described above, that is, a weight vector W at each layer controls a method of space transformation. An objective of training the deep neural network is to finally obtain a weight matrix (a weight matrix constituted by vectors W at a plurality of layers) of all layers of a trained neural network. Therefore, a process of training the neural network is essentially a manner of learning control of the space transformation, and more specifically, learning the weight matrix.

An output of the deep neural network shall be hopefully close, as much as possible, to an actually expected prediction value. Therefore, a prediction value and an actually expected target value of a current network may be compared, and then a weight vector of the neural network at each layer is updated based on a difference between the two values (certainly, there is usually an initialization process before the first update, to be specific, parameters are pre-configured for all layers of the deep neural network). For example, if the prediction value of the network is high, the weight vector is adjusted to make the prediction value to be smaller. Such adjustment is continuously performed until the neural network can obtain the actually expected target value through prediction. Therefore, “how to obtain, through comparison, a difference between the prediction value and the target value” needs to be predefined. This is a loss function (loss function) or an objective function (objective function). The loss function and the objective function are important equations used to measure the difference between the prediction value and the target value. The loss function is used as an example. A higher output value (loss) of the loss function indicates a larger difference. Therefore, training of the deep neural network becomes a process of reducing the loss as much as possible.

The accuracy prediction model 201 obtained by the training device 220 may be applied to different systems or devices. In FIG. 2, an execution device 210 is configured with an I/O interface 212, and exchanges data with an external device. For example, a detection image sent by user equipment 240 is received by using the I/O interface 212.

The execution device 210 may invoke data, code, and the like that are in a data storage system 250, or may store the data, the instruction, and the like in the data storage system 250.

A calculation module 211 processes input data by using the accuracy prediction model 201. Specifically, the calculation module 211 inputs a search space into the accuracy prediction model 201 for prediction, to obtain a target neural network and accuracy of the target neural network, and sends the target neural network to the user equipment 240 by using the I/O interface.

More deeply, the training device 220 may generate, for different objectives, corresponding accuracy prediction models 201 based on different search spaces, to meet different requirements of a user.

After the accuracy of the neural network is obtained, the target neural network and the accuracy of the target neural network may be stored in the database 230 for training the accuracy prediction model next time.

It should be noted that, FIG. 2 is merely a schematic diagram of a system architecture according to an embodiment of the present application. Position relationships between devices, components, modules, and the like shown in the figure do not constitute any limitation. For example, in FIG. 2, the data storage system 250 is an external memory relative to the execution device 210, and in another case, the data storage system 250 may alternatively be disposed in the execution device 210.

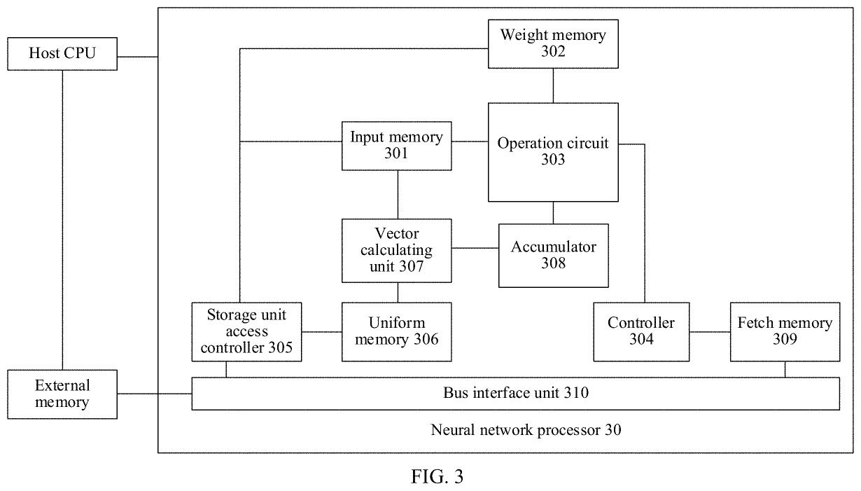

FIG. 3 is a structural diagram of chip hardware according to an embodiment of the present application. A neural network processor NPU 30, as a coprocessor, is mounted on a host CPU. The host CPU assigns tasks to the neural network processor.

A core part of the NPU is an operation circuit 303, a controller 304 controls the operation circuit 303 to extract data in a memory (a weight memory or an input memory) and calculates the data.

In some implementations, the operation circuit 303 internally includes a plurality of processing units (process engine, PE).

In some implementations, the operation circuit 303 is a two-dimensional systolic array. The operation circuit 303 may alternatively be a one-dimensional systolic array or another electronic circuit that can perform mathematical operations such as multiplication and addition. In some implementations, the operation circuit 303 is a general-purpose matrix processor.

For example, it is assumed that there are an input matrix A, a weight matrix B, and an output matrix C. The operation circuit obtains data corresponding to the matrix B from a weight memory 302, and caches the data on each PE in the operation circuit. The operation circuit obtains data of the matrix A from an input memory 301 and data of the matrix B to perform a matrix operation, and a part of the obtained result or a final result of the matrix is stored in an accumulator 308. A vector calculating unit 307 may further process an output of the operation circuit, for example, vector multiplication, vector addition, an index operation, a logarithm operation, and size comparison. For example, the vector calculating unit 307 may be configured for a network calculation at a non-convolution/non-FC layer in a neural network, such as pooling, batch normalization, or local response normalization.

In some implementations, the vector calculating unit 307 can store a processed output vector in a uniform cache 306. For example, the vector calculating unit 307 may apply a non-linear function to the output of the operation circuit 303, such as a vector of an accumulation value, to generate an activation value. In some implementations, the vector calculating unit 307 generates a normalization value, or a combination value, or both a normalization value and a combination value.

In some implementations, the processed output vector can be used as an input for activating the operation circuit 303, for example, used for usage in a subsequent layer in the neural network.

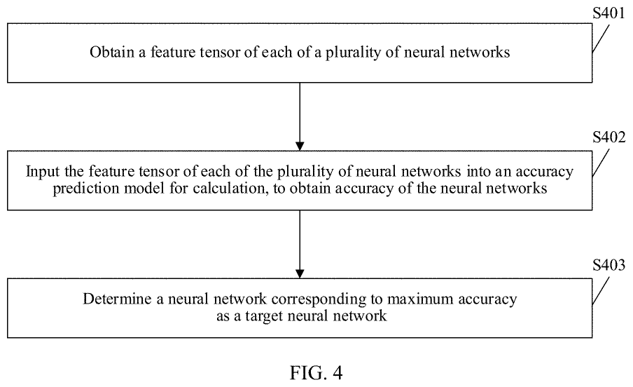

For example, the vector calculating unit 307 or the operation circuit 303 in the NPU 30 is configured to perform training to obtain an accuracy prediction model and use the accuracy prediction model to obtain accuracy of the neural network. For a specific process, refer to related descriptions in the embodiment shown in FIG. 4.

The uniform memory 306 is configured to store input data and output data. A storage unit access controller 305 (DMAC) transports the input data in an external memory to the input memory 301 or the uniform memory 306, stores weight data of the external memory in the weight memory 302, and stores data of the uniform memory 306 in the external memory. A bus interface unit (BIU) 310 is configured to implement interaction among the host CPU, the DMAC, and a fetch memory 309 by using buses. The fetch memory (instruction fetch buffer) 309 connected to the controller 304 is configured to store an instruction used by the controller 304; and the controller 304 is configured to invoke the instruction cached in the fetch memory 309, to control a working process of the operation accelerator.

Usually, the uniform memory 306, the input memory 301, the weight memory 302, and the fetch memory 309 are all on-chip memories, the external memory is a memory outside the NPU, and the external memory may be a double data rate synchronous dynamic random memory (DDR SDRAM for short), a high bandwidth memory (HBM), or another readable and writable memory. The NPU 30 is configured to: train an initial prediction model based on training data, to obtain the accuracy prediction model, and input a feature tensor of the neural network into the accuracy prediction model, to obtain the accuracy of the neural network through calculation. For a specific process, refer to related descriptions in the embodiment shown in FIG. 4.

FIG. 4 is a schematic flowchart of a neural network search method according to an embodiment of the present application. As shown in FIG. 4, the method includes the following steps.

S401: Obtain a feature tensor of each of a plurality of neural networks.

The feature tensor of each neural network is used to represent a computing capability of the neural network, and the computing capability of the neural network is related to a network structure and a parameter of the neural network.

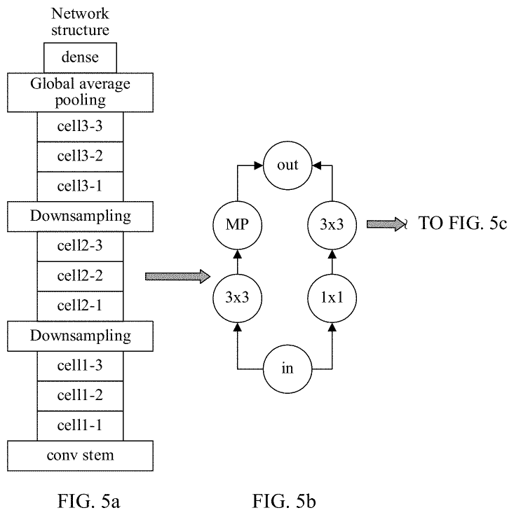

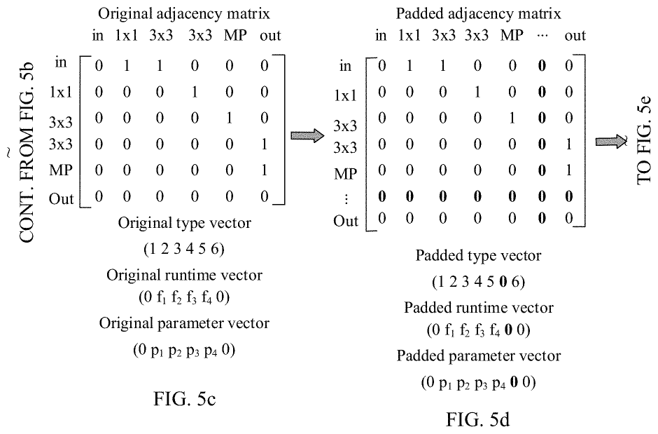

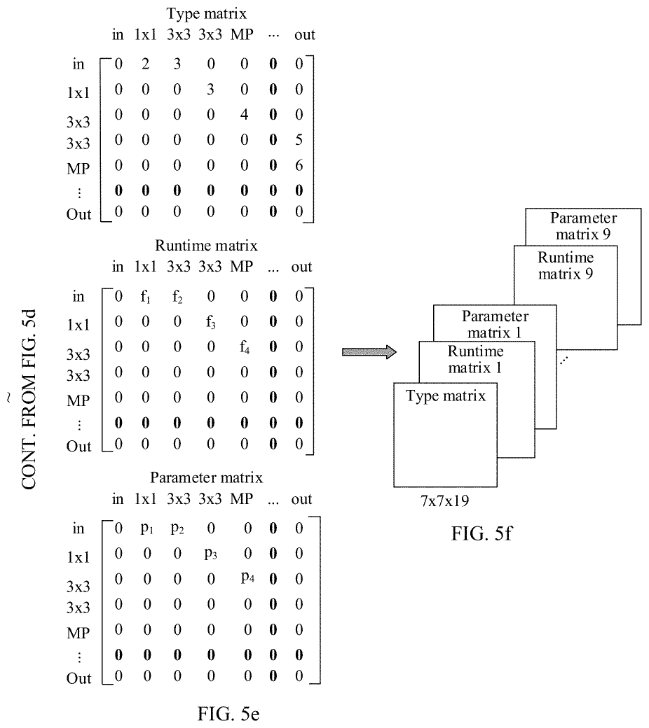

It should be noted herein that, before the feature tensor of the neural network, a search space needs to be given first, and then the feature tensor of each neural network in the search space is obtained. The search space is a search space of a directed acyclic graph, and the so-called search space of the directed acyclic graph is that in the search space, structures of all neural networks share a supernetwork formed by superimposing several same units, as shown in FIG. 5a. A difference between different neural network structures lies in that the units constituting the supernetwork are different.

In a feasible embodiment, the obtaining a feature tensor of each of a plurality of neural networks includes:

obtaining a directed acyclic graph of each unit in each of the plurality of neural networks; obtaining, based on the directed acyclic graph of each unit in each neural network, an adjacency matrix, a type vector, a runtime vector, and a parameter vector that correspond to each unit in each neural network, where the runtime vector is related to a hardware resource; determining a type matrix, a runtime matrix, and a parameter matrix of each unit based on the adjacency matrix, the type vector, the runtime vector, and the parameter vector of each unit in each neural network; and determining the tensor feature of each neural network based on the type matrix, the runtime matrix, and the parameter matrix of the unit in each neural network.

It should be noted that an element in the runtime vector of each unit is a time required for performing, on hardware, an operation, for example, 3×3 convolution or 1×1 convolution, in the unit. For example, if a unit includes the 3×3 convolution, 3×3 pooling, the 1×1 convolution, and 1×1 pooling, a runtime vector corresponding to the unit includes four elements, respectively corresponding to times required for performing the 3×3 convolution, the 3×3 pooling, the 1×1 convolution, and the 1×1 pooling on the hardware.

In addition, it should be noted that a size of the element in the runtime vector is related to a hardware resource and a calculation amount required for an operation in the unit. When the hardware resource is larger, the calculation amount required for the operation in the unit is smaller, and an element in a corresponding runtime is smaller.

Specifically, as shown in FIG. 5, different units in each neural network may be represented as a directed acyclic graph. As shown in FIG. 5b, the directed acyclic graph includes a plurality of nodes, such as an input node and an output node. A directed acyclic graph of a unit is given, and a structure of the unit may be represented by an adjacency matrix and a type vector. Further, to better represent a computing capability of a network structure, a runtime vector and a parameter vector are added, as shown in FIG. 5c. It should be noted that, quantities of nodes in different directed acyclic graph units may be different. For ease of calculation, it is assumed that there is a maximum quantity of nodes, and a zero adding operation is performed on the adjacency matrix and each vector until both a size of the adjacency matrix and a length of each vector reach the maximum quantity of nodes. Because the first node always represents an input node, and the last node always represents an output node, for the adjacency matrix, the zero adding operation can be performed only between the first row and the last row, and between the first column and the last column; and for a vector, the zero adding operation can be performed only between the first element and the last element. As shown in FIG. 5d, for the adjacency matrix, the zero adding operation is performed between a penultimate row and a penultimate column, to obtain a padded adjacency matrix; and for the vector, zero is added to a penultimate location, to obtain a padded vector, where the padded vector includes a padded type vector, a padded parameter vector, and a padded runtime vector.

Then, the type matrix, the runtime matrix, and the parameter matrix are obtained based on the padded adjacency matrix, the padded type vector, the padded runtime vector, and the padded parameter vector. The padded type matrix is obtained by multiplying the padded type vector by the padded adjacency matrix, the padded runtime matrix is obtained by multiplying the padded runtime vector by the padded adjacency matrix, and the padded parameter matrix is obtained by multiplying the padded parameter vector by the padded adjacency matrix, as shown in FIG. 5e. Finally, the padded matrices are spliced to obtain the feature tensor of the neural network, as shown in FIG. 5f. Because type matrices corresponding to all units in a neural network are the same, only one type matrix is used during matrix splicing.

S402: Input the feature tensor of each of the plurality of neural networks into the accuracy prediction model for calculation, to obtain accuracy of the neural network.

The accuracy prediction model is obtained through training by a ranking-based loss function. The accuracy of the neural network is an evaluation standard of a processing result of task processing performed by using the network. For example, when a neural network is used to perform image classification, accuracy of the neural network is an accuracy rate of the image classification. For another example, when a neural network is used to perform image detection, accuracy of the neural network is mean average accuracy of the image detection. For still another example, when a neural network is used to perform image segmentation, accuracy of the neural network is a mean intersection-over-union rate of the image segmentation.

As shown in FIG. 5, input data of the prediction model is an obtained feature tensor of the neural network. In this method, LeNet-5 is used as a prediction model to predict the accuracy of the neural network. A number at the bottom of the figure indicates a dimension, which is for reference only. The number may be correspondingly changed based on a dimension of the feature tensor.

In a feasible embodiment, before that input the feature tensor of each of the plurality of neural networks into the accuracy prediction model for calculation, to obtain the accuracy of the neural networks, the neural network search method further includes:

obtaining the accuracy prediction model; where

the obtaining the accuracy prediction model includes:

obtaining training data and an initial prediction model, where the training data includes feature tensors of the plurality of neural networks and real accuracy corresponding to the neural networks; inputting the feature tensors of the plurality of neural networks into the initial prediction model for calculation, to obtain a plurality of pieces of prediction accuracy; obtaining a loss value through calculation based on the plurality of pieces of prediction accuracy, a plurality of pieces of real accuracy, and a ranking-based loss function; and adjusting a parameter in the initial prediction model based on the loss value, to obtain the accuracy prediction model.

In a feasible embodiment, the accuracy prediction model is obtained from a third-party training device.

The ranking-based loss function is a first loss function, and the first loss function is used to measure a relationship between ranking of the accuracy that is of the neural networks and that is predicted by the accuracy prediction model and ranking of real accuracy of the networks.

A lower degree at which the ranking of the accuracy that is of the neural networks and that is predicted based on the accuracy prediction model is the same as the ranking of the real accuracy of the neural networks indicates a larger loss value obtained based on the first loss function, or a higher degree at which the ranking of the accuracy that is of the neural networks and that is predicted based on the accuracy prediction model is the same as the ranking of the real accuracy of the neural networks indicates a smaller loss value obtained based on the first loss function. Therefore, a case in which ranking of predicted model accuracy is inconsistent with ranking of real model accuracy is punished, so that ranking of predicted accuracy output by a trained model is hopefully consistent with real ranking as much as possible.

For example, a real neural network ranking result is “N1, N2, N3, N4, N5”, N3 is ranked before N4, and N4 is ranked before N5. A predicted neural network ranking result includes “N1, N2, N4, N3, N5” and “N1, N2, N4, N5, N3”, in the former (“N1, N2, N4, N5, N3”), N3 is ranked after N4, and in the latter (“N1, N2, N4, N5, N3”), N3 is ranked after N4 and N3 is ranked after N5. It can be seen that the former has a higher degree of similarity than the latter.

Specifically, the first loss function may be represented as:

[symbol]

₁(W)=Σᵢ₌₁ⁿ⁻¹Σⱼ₌ᵢ₊₁ⁿφ((ε(Nᵢ)−(Nⱼ))*sign(yᵢ−yⱼ)),

where Nᵢ and Nⱼ are respectively an i^{th} neural network and a j^{th} neural network that are used when training a model, ε(Nᵢ) and ε(Nⱼ) are respectively accuracy obtained through calculation by inputting Nᵢ and Nⱼ into the prediction model, and yᵢ and yⱼ are respectively real accuracy of Nᵢ and Nⱼ.

φ(z)=(1−z)₊ is a hinge function. A pair of data is given, the loss function is zero only if accuracy of the pair of data is ranked correctly and a difference between the accuracy is large enough. φ(z) may be another monotonically non-increasing function, for example, a logistic function φ(z)=log (1+e^{-z}) or an exponential function φ(z)=e^{-z}.

Because the feature before the last fully-connected layer of the accuracy prediction model is also useful, a second loss function is introduced. The foregoing ranking-based loss function is obtained by performing a linear combination on the first loss function and the second loss function, and the first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

When a distance between two neural networks with similar accuracy in the feature space is longer, or a distance between two neural networks with different accuracy in the feature space is shorter, a loss value obtained based on the second loss function is larger. Alternatively, when a distance between two neural networks with similar accuracy in the feature space is shorter, or a distance between two neural networks with different accuracy in the feature space is longer, a loss value obtained based on the second loss function is smaller, thereby assigning continuity to a feature.

The second loss function may be represented as:

[symbol]

₂(W)=Σᵢ₌₁ⁿ⁻²Σⱼ₌ᵢ₊₁ⁿ⁻¹Σₖ₌ⱼ₊₁ⁿφ((dᵢⱼ−dᵢₖ)*Sign(lᵢⱼ−lᵢₖ)),

where dᵢⱼ=∥\tilde{ε}(Nᵢ)−\tilde{ε}(Nⱼ)∥₂, a difference between accuracy of two network structures may be represented as lᵢⱼ=|yᵢ−yⱼ|, where \tilde{ε}(Nᵢ) and \tilde{ε}(Nⱼ) are respectively features input into a last fully-connected layer in a prediction model after Nᵢ and Nⱼ are input into the prediction model.

The ranking-based loss function may be represented as:

[symbol]

= [symbol] ₁+λ [symbol] ₂,

where λ is a hyperparameter for controlling importance of the first loss function [symbol] ₁ and the second loss function [symbol] ₂.

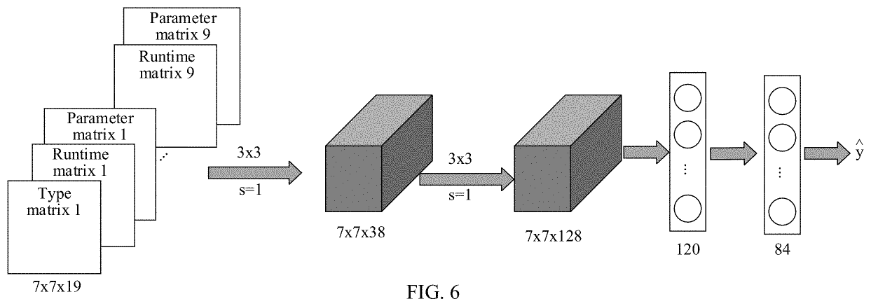

Specifically, n different network structures are given, and real accuracy of the n different network structures is used as training data {(Nᵢ, yᵢ)}ᵢ₌₁ⁿ. In addition, {ε(Nᵢ; W)}ᵢ₌₁ⁿ (briefly referred to as ε(Nᵢ)) represents accuracy (namely, ŷ in FIG. 6) obtained through prediction by using the LeNet-5 (namely, the prediction model). It is defined that the prediction model is trained based on a ranking loss function of a pair of elements, or the prediction model may be trained based on a ranking loss function of a plurality of elements. A ranking loss function that is based on a pair of elements, namely, the foregoing first loss function, is:

$${ℒ}_{1} ( W ) = {\sum }_{i = 1}^{n - 1} {\sum }_{j = i + 1}^{n} ϕ ( ( ɛ ( {N}_{i} ) - ɛ ( {N}_{j} ) ) * sign ( {y}_{i} - {y}_{j} ) )$$

In addition to constructing a loss function by using a final output result of the prediction model, the feature before the last fully-connected layer of the prediction model (namely, the feature input to the last fully-connected layer of the prediction model) is also useful. It is noted that continuity hypothesis is very common in machine learning. However, the hypothesis does not exist for an original neural network structure. For example, for any neural network, adding a shortcut on the neural network has little impact on changes of the neural network structure, but has great impact on final accuracy. Therefore, a feature having a continuity property is hopefully learned.

Specifically, a triplet {\tilde{ε}(Nᵢ;W),yᵢ}ᵢ₌₁³, is considered, where \tilde{ε}(Nᵢ;W) (briefly referred to as \tilde{ε}(Nᵢ)) is the feature before the last fully-connected layer of the prediction model. A Euclidean distance between features of two neural networks may be calculated through dᵢⱼ=∥\tilde{ε}(Nᵢ)−\tilde{ε}(Nⱼ)∥₂, and a difference between accuracy of the two neural networks may be represented as lᵢⱼ=|yᵢ−yⱼ|. Therefore, the following loss function is optimized to obtain the feature having the continuity property:

[symbol]

₂(W)=Σᵢ₌₁ⁿ⁻²Σⱼ₌ᵢ₊₁ⁿ⁻¹Σₖ₌ⱼ₊₁ⁿφ((dᵢⱼ−dᵢₖ)*sign(lᵢⱼ−lᵢₖ)).

A final ranking-based loss function is a linear combination of the foregoing two loss functions:

[symbol]

= [symbol] ₁+λ [symbol] ₂,

where λ is a hyperparameter for controlling importance of the two loss functions.

Finally, a trained prediction model may be used in an existing search process based on an evolutionary algorithm or a reinforcement learning method, or may be embedded in a search method such as traversal search or random search.

S403: Determine a neural network corresponding to maximum accuracy as a target neural network.

After accuracy of each neural network in a search space is obtained, the neural network corresponding to the maximum accuracy in the search space is determined as the target neural network. Then, the target neural network is used to perform tasks such as classification, segmentation, detection, and super-resolution.

It can be learned that in the solution of this application, a ranking-based accuracy prediction model is introduced, so that the ranking of the accuracy that is of the neural networks and that is predicted based on the prediction accuracy model is the same as the rank of the real accuracy of the neural networks, thereby ensuring that accuracy of a network structure found through search can be significantly improved. In addition, the tensor feature extraction method proposed in this application can be applied to all search spaces based on the directed acyclic graph, can well reflect computing capabilities of different network structures, and can significantly improve accuracy of the network structure found through search.

Further, the present application is tested on a dataset NAS-Bench-101.

The dataset includes about 423,000 neural networks of different structures and real accuracy obtained after training on a CIFAR-10 dataset.

To test the feature extraction method and a function of the loss function in the present application, the present application may be divided into six different versions:

(1) ReNAS-1 (type matrix+MSE): Only a type matrix constituted by an adjacency matrix and a type vector is used as a feature, and a minimum mean square error loss function is used.

(2) ReNAS-2 (tensor+MSE): The feature tensor proposed in the present application is used, and the minimum mean square error loss function is used.

(3) ReNAS-3 (type matrix+ [symbol] ₁): Only the type matrix constituted by the adjacency matrix and the type vector is used as the feature, and a first loss function [symbol] ₁ proposed in the present application is used.

(4) ReNAS-4 (tensor+ [symbol] ₁): The feature tensor proposed in the present application is used, and the first loss function [symbol] ₁ proposed in the present application is used.

(5) ReNAS-5 (type matrix+ [symbol] ): Only the type matrix constituted by the adjacency matrix and the type vector is used as the feature, and a loss function L provided in the present application is used.

(6) ReNAS-6 (tensor+ [symbol] ): The feature tensor proposed in the present application is used, and the loss function [symbol] proposed in the present application is used.

To test effects that are of a predictor and that are obtained by using different methods, Kendall's Tau (KTau) is used as the evaluation standard of the predictor. KTau is a ranking-related indicator, and a value of the KTau ranges from −1 to 1. When predicted ranking of a group of samples is totally the same as real ranking, KTau=1; when the predicted ranking is totally opposite to the real ranking, KTau=1; or when the predicted ranking is unrelated to the real ranking, KTau is about 0.

$$K T a u = 2 \times \frac{n u m b e r o f c o n c o r d a n t p a i r s}{{C}_{n}^{2}} - 1$$

The following table shows KTau values obtained by using different methods when data in NAS-Bench-101 datasets of different proportions is used as training data. As shown in Table 1, Table 1 shows effects of the predictor when different quantities of training data are used.

TABLE 1

| Methods | 0.1% | 1% | 10% | 30% | 50% | 70% | 90% |
|---|---|---|---|---|---|---|---|
| Peephole [3] | 0.4556 | 0.4769 | 0.4963 | 0.4977 | 0.4972 | 0.4975 | 0.4951 |
| E2EPP [24] | 0.5038 | 0.6734 | 0.7009 | 0.6997 | 0.7011 | 0.6992 | 0.6997 |
| ReNAS-1 | 0.3465 | 0.5911 | 0.7914 | 0.8229 | 0.8277 | 0.8344 | 0.8350 |
| (type matrix + MSE) | | | | | | | |
| ReNAS-2 | 0.4856 | 0.6090 | 0.8103 | 0.8430 | 0.8399 | 0.8504 | 0.8431 |
| (tensor + MSE) | | | | | | | |
| ReNAS-3 | 0.6039 | 0.7943 | 0.8752 | 0.8894 | 0.8949 | 0.8976 | 0.8995 |
| (type matrix + [symbol] ) | | | | | | | |
| ReNAS-4 | 0.6335 | 0.8136 | 0.8762 | 0.8900 | 0.8957 | 0.8979 | 0.8997 |
| (tensor + [symbol] ) | | | | | | | |
| ReNAS-5 | 0.6096 | 0.7949 | 0.8756 | 0.8854 | 0.8898 | 0.8911 | 0.8918 |
| (type matrix + [symbol] ) | | | | | | | |
| ReNAS-6 | 0.6574 | 0.8161 | 0.8763 | 0.8873 | 0.8910 | 0.8923 | 0.8954 |
| (tensor + [symbol] ) | | | | | | | |

It can be seen that the neural network search method of the present application has advantages in ranking different network structures.

Then, the predictor is trained by using 0.1% training data, and an obtained predictor is used to search for a neural network. Search results are shown in Table 2. Table 2 shows search results of the predictor on the NAS-Bench-101 CIFAR-10.

TABLE 2

| Methods | Accuracy (%) | Ranking (%) |
|---|---|---|
| Peephole [3] | 92.63 ± 0.31 | 12.32 |
| E2EPP [24] | 93.47 ± 0.44 | 1.23 |
| ReNAS-1 | 92.36 ± 0.27 | 16.93 |
| ReNAS-2 | 93.03 ± 0.21 | 6.09 |
| ReNAS-3 | 93.43 ± 0.26 | 1.50 |
| ReNAS-4 | 93.90 ± 0.21 | 0.04 |
| ReNAS-5 | 93.48 ± 0.18 | 1.21 |
| ReNAS-6 | 93.95 ± 0.11 | 0.02 |

Accuracy shown in Table 2 is the accuracy of a network structure found through search, and ranking shown in Table 2 is a rank of the network structure in a current search space. It can be seen that the method has significant advantages.

Finally, to verify performance of an unknown search space, a network structure that same as the NAS-Bench-101 is used, and 0.1% data is randomly selected and trained on the CIFAR-100 dataset to obtain real accuracy of the data for training the predictor. The obtained predictor is configured to predict performance of a good network model on the CIFAR-100 dataset, and results are shown in the following Table 3:

TABLE 3

| Method | Peephole [3] | E2EPP [24] | Proposed |
|---|---|---|---|
| Top-1 acc (%) | 73.58 | 75.49 | 78.56 |
| Top-1 acc (%) | 91.97 | 92.77 | 94.17 |

In conclusion, accuracy of a neural network found through search by using the method in the present application is far higher than the accuracy of a neural network found through search by using another newly proposed similar method.

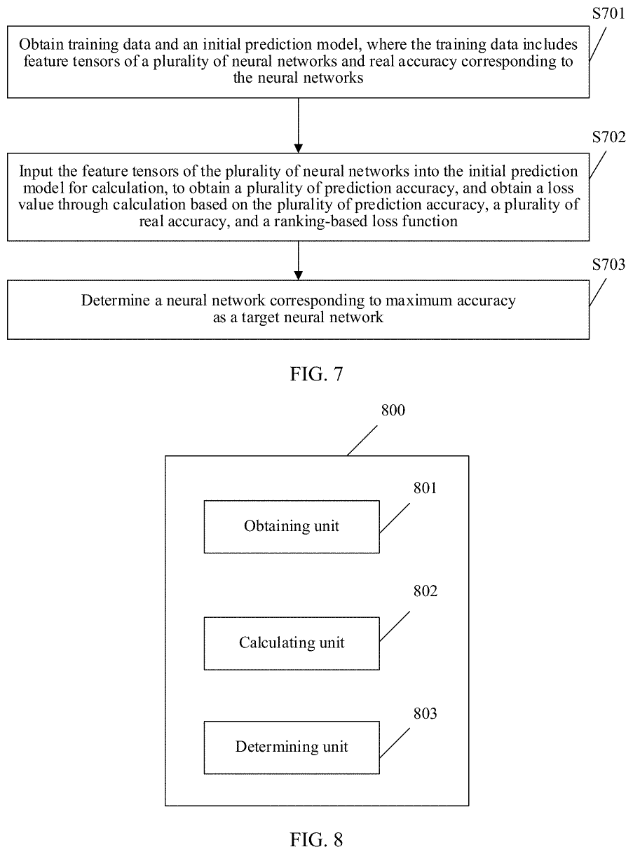

FIG. 7 is a schematic flowchart of a training method of an accuracy prediction model according to an embodiment of the present application. As shown in FIG. 7, the method includes the following steps:

S701: Obtain training data and an initial prediction model, where the training data includes feature tensors of a plurality of neural networks and real accuracy corresponding to the neural networks.

S702: Input the feature tensors of the plurality of neural networks into the initial prediction model for calculation, to obtain a plurality of pieces of prediction accuracy, and obtain a loss value through calculation based on the plurality of pieces of prediction accuracy, a plurality of pieces of real accuracy, and a ranking-based loss function.

S703: Adjust a parameter in the initial prediction model based on the loss value, to obtain an accuracy prediction model.

In a feasible embodiment, the ranking-based loss function is a first loss function, and the first loss function is used to measure a relationship between ranking of accuracy that is of the neural networks and that is predicted by the accuracy prediction model and ranking of real accuracy of the neural networks.

A lower degree at which the ranking of the accuracy that is of the neural networks and that is predicted based on the accuracy prediction model is the same as the ranking of the real accuracy of the neural networks indicates a larger loss value obtained based on the first loss function; or a higher degree at which the ranking of the accuracy that is of the neural networks and that is predicted based on the accuracy prediction model is the same as the ranking of the real accuracy of the neural networks indicates a smaller loss value obtained based on the first loss function.

Further, the first loss function is:

[symbol]

₁(W)=Σᵢ₌₁ⁿ⁻¹Σⱼ₌ᵢ₊₁ⁿφ((ε(Nᵢ)−(Nⱼ))*sign(yᵢ−yⱼ)),

where Nᵢ and Nⱼ are respectively an i^{th} neural network and a j^{th} neural network that are used when training a model, ε(Nᵢ) and ε(Nⱼ) are respectively accuracy obtained through calculation by inputting Nᵢ and Nⱼ into the prediction model, and yᵢ and yⱼ are respectively real accuracy of Nᵢ and Nⱼ.

φ(z)=(1−z)₊ is a hinge function. A pair of data is given, the loss function is zero only if accuracy of the pair of data is ranked correctly and a difference between the accuracy is large enough. φ(z) may be another monotonically non-increasing function, for example, a logistic function φ(z)=log (1+e^{-z}) or an exponential function φ(z)=e^{-z}.

In a feasible embodiment, the ranking-based loss function is obtained by performing a linear combination on the first loss function and a second loss function.

The first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

Further, the ranking-based loss function is:

[symbol]

= [symbol] ₁+λ [symbol] ₂.

Here λ is a constant, [symbol] ₁ is a first loss function, [symbol] ₂ is a second loss function, and the first loss function [symbol] ₁ is:

[symbol]

₁(W)=Σᵢ₌₁ⁿ⁻¹Σⱼ₌ᵢ₊₁ⁿφ((ε(Nᵢ)−(Nⱼ))*sign(yᵢ−yⱼ)).

Here Nᵢ and Nᵢ are respectively an i^{th} neural network and a j^{th} neural network that are used when training a model, ε(Nᵢ) and ε(Nⱼ) are respectively accuracy obtained through calculation by inputting Nᵢ and Nⱼ into the prediction model, and yᵢ and yᵢ are respectively real accuracy of Nᵢ and Nⱼ.

φ(z)=(1−z)₊ is a hinge function. A pair of data is given, the loss function is zero only if accuracy of the pair of data is ranked correctly and a difference between the accuracy is large enough. φ(z) may be another monotonically non-increasing function, for example, a logistic function φ(z)=log (1+e^{-z}) or an exponential function φ(z)=.

The second loss function [symbol] ₂ is:

[symbol]

₂(W)=Σᵢ₌₁ⁿ⁻²Σⱼ₌ᵢ₊₁ⁿ⁻¹Σₖ₌ⱼ₊₁ⁿφ((dᵢⱼ−dᵢₖ)*sign(lᵢⱼ−lᵢₖ)).

Here dᵢⱼ=∥ε(Nᵢ)−\tilde{ε}(Nⱼ)∥₂ a difference between accuracy of two network structures may be represented as lᵢⱼ=|yᵢ−yⱼ|, where \tilde{ε}(Nᵢ) and \tilde{ε}(Nⱼ) are respectively features input into a last fully-connected layer in a prediction model after Nᵢ and Nⱼ are input into the prediction model.

It should be noted herein that for a specific implementation process of steps S701 to S703, refer to related descriptions of step S402. Details are not described herein again.

FIG. 8 is a schematic structural diagram of a neural network predictor according to an embodiment of the present application. As shown in FIG. 8, the predictor 800 includes:

an obtaining unit 801, configured to obtain a feature tensor of each of a plurality of neural networks, where the feature tensor of each neural network is used to represent a computing capability of the neural network;

a calculating unit 802, configured to input the feature tensor of each of the plurality of neural networks into an accuracy prediction model for calculation, to obtain accuracy of the neural network, where the accuracy of the neural network is an evaluation standard of a processing result obtained by performing task processing by using the neural network, and the accuracy prediction model is obtained through training based on a ranking-based loss function; and

a determining unit 803, configured to determine a neural network corresponding to maximum accuracy as a target neural network.

In a feasible embodiment, the ranking-based loss function is a first loss function, and the first loss function is used to measure a relationship between ranking of the accuracy that is of the neural networks and that is predicted by the accuracy prediction model and ranking of real accuracy of the neural networks.

A lower degree at which the ranking of the accuracy that is of the neural networks and that is predicted based on the accuracy prediction model is the same as the ranking of the real accuracy of the neural networks indicates a larger loss value obtained based on the first loss function; or a higher degree at which the ranking of the accuracy that is of the neural networks and that is predicted based on the accuracy prediction model is the same as the ranking of the real accuracy of the neural networks indicates a smaller loss value obtained based on the first loss function.

In a feasible embodiment, the ranking-based loss function is obtained by performing a linear combination on the first loss function and a second loss function.

The first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

In a feasible embodiment, the obtaining unit 801 is configured to:

obtain a directed acyclic graph of each unit of each of the plurality of neural networks; obtain, based on the directed acyclic graph of each unit in each neural network, an adjacency matrix, a type vector, a runtime vector, and a parameter vector that correspond to each unit in each neural network, where the runtime vector is related to a hardware resource; determine a type matrix, a runtime matrix, and a parameter matrix of each unit based on the adjacency matrix, the type vector, the runtime vector, and the parameter vector are of each unit in each neural network; and determine the tensor feature of each neural network based on the type matrix, the runtime matrix, and the parameter matrix of the unit in each neural network.

In a feasible embodiment, data input into the calculating unit 802 may alternatively be an adjacency matrix, a type vector, a runtime vector, and a parameter vector of each unit of a neural network in the search space. The calculating unit 802 determines a type matrix, a runtime matrix, and a parameter matrix of each unit based on the adjacency matrix, the type vector, the runtime vector, and the parameter vector of each unit, then obtains the feature tensor of the neural network based on the type matrix, the runtime matrix, and the parameter matrix of each unit in the neural network, and finally, inputs the feature tensor of the neural network into the accuracy prediction model for calculation, to obtain the accuracy of the neural network.

Optionally, the foregoing adjacency matrix, type vector, runtime vector, and parameter vector may be obtained in another manner. The foregoing type matrix, runtime matrix, and parameter matrix may also be obtained in another manner.

In a feasible embodiment, the obtaining unit 801 is further configured to:

before the calculating unit 802 inputs the feature tensor of each of the plurality of neural networks into the accuracy prediction model for calculation, to obtain the accuracy of the neural networks, obtain the accuracy prediction model.

In an aspect of obtaining the accuracy prediction model, the obtaining unit 801 is configured to:

obtain training data and an initial prediction model, where the training data includes feature tensors of the plurality of neural networks and real accuracy corresponding to the neural networks; input the feature tensors of the plurality of neural networks into the initial prediction model for calculation, to obtain a plurality of pieces of prediction accuracy; obtain a loss value through calculation based on the plurality of pieces of prediction accuracy, a plurality of pieces of real accuracy, and a ranking-based loss function; and adjust a parameter in the initial prediction model based on the loss value, to obtain the accuracy prediction model.

In a feasible embodiment, the obtaining unit 801 is further configured to:

before the calculating unit 802 inputs the feature tensor of each of the plurality of neural networks into the accuracy prediction model for calculation, to obtain the accuracy of the neural networks, obtain the accuracy prediction model from a training device.

It should be noted that, the foregoing units (the obtaining unit 801, the calculating unit 802, and the determining unit 803) are configured to perform related steps in the foregoing method. For example, the obtaining unit 801 is configured to perform related content of S401, the calculating unit 801 is configured to perform related content of S402, and the determining unit 803 is configured to perform related content of S403.

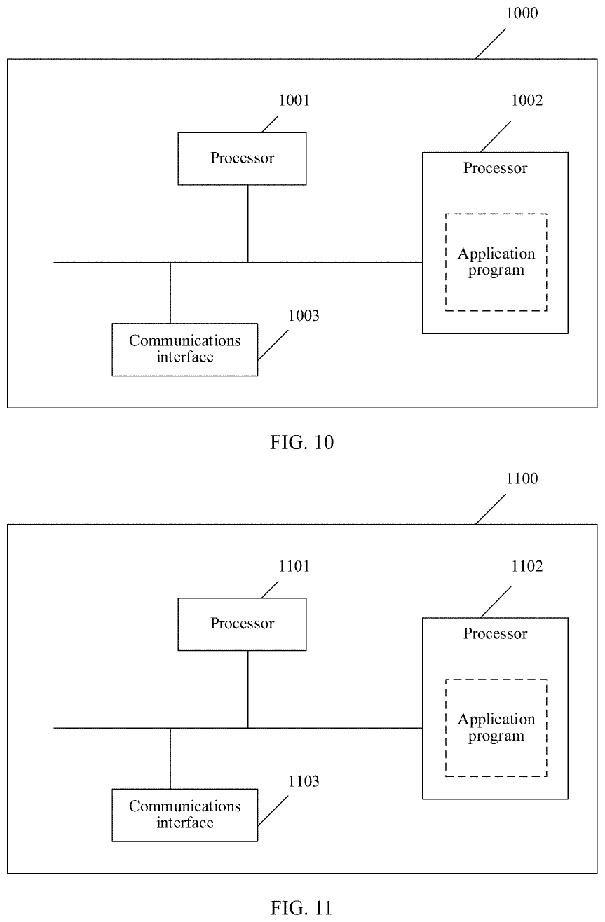

In this embodiment, the predictor 800 is presented in a form of a unit. The “unit” herein may be an application-specific integrated circuit (ASIC), a processor and a memory that execute one or more software or firmware programs, an integrated logic circuit, and/or another device that can provide the foregoing functions. In addition, the foregoing obtaining unit 801, calculating unit 802, and determining unit 803 may be implemented by using the processor 1101 of the neural network predictor shown in FIG. 10.

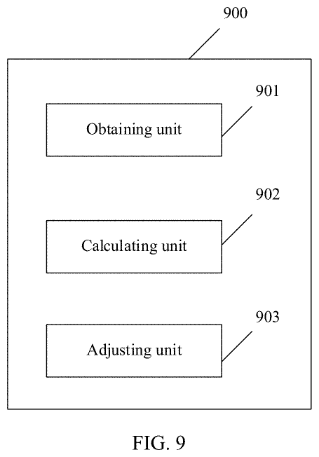

FIG. 9 is a schematic structural diagram of a training device according to an embodiment of the present application. As shown in FIG. 9, the training device 900 includes:

an obtaining unit 901, configured to obtain training data and an initial prediction model, where the training data includes feature tensors of a plurality of neural networks and real accuracy corresponding to the neural networks;

a calculating unit 902, configured to: input the feature tensors of the plurality of neural networks into the initial prediction model for calculation, to obtain a plurality of pieces of prediction accuracy; and obtain a loss value through calculation based on the plurality of pieces of prediction accuracy, a plurality of pieces of real accuracy, and a ranking-based loss function; and

an adjusting unit 903, configured to adjust a parameter in the initial prediction model based on the loss value, to obtain the accuracy prediction model.

In a feasible embodiment, the ranking-based loss function is a first loss function, and the first loss function is used to measure a relationship between ranking of the accuracy that is of the neural networks and that is predicted by the accuracy prediction model and ranking of real accuracy of the neural networks.

A lower degree at which the ranking of the accuracy that is of the neural networks and that is predicted based on the accuracy prediction model is the same as the ranking of the real accuracy of the neural networks indicates a larger loss value obtained based on the first loss function; or a higher degree at which the ranking of the accuracy that is of the neural networks and that is predicted based on the accuracy prediction model is the same as the ranking of the real accuracy of the neural networks indicates a smaller loss value obtained based on the first loss function.

In a feasible embodiment, the ranking-based loss function is obtained by performing a linear combination on the first loss function and a second loss function.

The first loss function is used to measure the relationship between the ranking of the accuracy that is of the neural networks and that is predicted by the accuracy prediction model and the ranking of the real accuracy of the neural networks, and the second loss function is used to measure a relationship between a distance between the neural networks in a feature space and a difference between the real accuracy of the neural networks.

It should be noted that, the foregoing units (the obtaining unit 901, the calculating unit 902, and the adjusting unit 903) are configured to perform related steps in the foregoing method. For example, the obtaining unit 901 is configured to perform related content of S701, the calculating unit 902 is configured to perform related content of S702, and the adjusting unit 903 is configured to perform related content of S703.

In this embodiment, the training device 900 is presented in a form of a unit. The “unit” herein may be an application-specific integrated circuit (ASIC), a processor and a memory that execute one or more software or firmware programs, an integrated logic circuit, and/or another device that can provide the foregoing functions. In addition, the foregoing obtaining unit 901, calculating unit 902, and adjusting unit 903 may be implemented by using the processor 1101 of the training device shown in FIG. 11.

The neural network predictor 1000 shown in FIG. 10 may be implemented by using the structure in FIG. 11. The neural network predictor 1000 includes at least one processor 1001, at least one memory 1002, and at least one communications interface 1003. The processor 1001, the memory 1002, and the communications interface 1003 are connected to and communicate with each other by using the communications bus.

The processor 1001 may be a general-purpose central processing unit (CPU), a microprocessor, an application-specific integrated circuit (ASIC), or one or more integrated circuits configured to control execution of the foregoing solution program.

The communications interface 1003 is configured to communicate with another device or a communications network such as the Ethernet, a radio access network (RAN), or a wireless local area network (WLAN).

The memory 1002 may be a read-only memory (ROM) or another type of static storage device that can store static information and a static instruction; or a random access memory (RAM) or another type of dynamic storage device that can store information and an instruction; or may be an electrically erasable programmable read-only memory (EEPROM), a compact disc read-only memory (CD-ROM) or another compact disc storage medium, an optical disc storage medium (including a compact disc, a laser disc, an optical disc, a digital versatile disc, a Blu-ray disc, or the like), or a magnetic disk storage medium, another magnetic storage device, or any other medium that can be configured to carry or store expected program code in a form of an instruction or a data structure and that can be accessed by a computer. This is not limited herein. The memory may exist independently, or may be connected to the processor by using the bus. The memory may alternatively be integrated with the processor.

The memory 1002 is configured to store the application program code executing the foregoing solution, and the execution is controlled by the processor 1001. The processor 1001 is configured to execute the application program code stored in the memory 1002.

The code stored in the memory 1002 may execute any neural network search method provided above, for example, obtain a feature tensor of each of a plurality of neural networks, where the feature tensor of each neural network is used to represent a computing capability of the neural network; input the feature tensor of each of the plurality of neural networks into an accuracy prediction model for calculation, to obtain accuracy of the neural network, where the accuracy of the neural network is an evaluation standard of a processing result obtained by performing task processing by using the neural network, and the accuracy prediction model is obtained through training based on a ranking-based loss function; and determine a neural network corresponding to maximum accuracy as a target neural network.

As shown in FIG. 11, a training device 1100 may be implemented by using the structure in FIG. 11. The training device 1100 includes at least one processor 1101, at least one memory 1102, and at least one communications interface 1103. The processor 1101, the memory 1102, and the communications interface 1103 are connected to and communicate with each other by using the communications bus.

The processor 1101 may be a general-purpose central processing unit (CPU), a microprocessor, an application-specific integrated circuit (ASIC), or one or more integrated circuits configured to control execution of the foregoing solution program.

The communications interface 1103 is configured to communicate with another device or a communications network such as the Ethernet, a radio access network (RAN), or a wireless local area network (WLAN).

The memory 1102 may be a read-only memory (ROM) or another type of static storage device that can store static information and a static instruction; or a random access memory (RAM) or another type of dynamic storage device that can store information and an instruction; or may be an electrically erasable programmable read-only memory (EEPROM), a compact disc read-only memory (CD-ROM) or another compact disc storage medium, an optical disc storage medium (including a compact disc, a laser disc, an optical disc, a digital versatile disc, a Blu-ray disc, or the like), or a magnetic disk storage medium, another magnetic storage device, or any other medium that can be configured to carry or store expected program code in a form of an instruction or a data structure and that can be accessed by a computer. This is not limited herein. The memory may exist independently, or may be connected to the processor by using the bus. The memory may alternatively be integrated with the processor.

The memory 1102 is configured to store the application program code executing the foregoing solution, and the execution is controlled by the processor 1101. The processor 1101 is configured to execute the application code stored in the memory 1102.

The code stored in the memory 1102 may perform any XX method provided above, for example:

An embodiment of the present application further provides a computer storage medium, the computer storage medium may store a program, and when being executed, the program includes some or all steps of any neural network search method or training method of an accuracy prediction model set forth in the foregoing method embodiments.

It should be noted that, to make the description brief, the foregoing method embodiments are expressed as a series of actions. However, a person skilled in the art should appreciate that the present application is not limited to the described action sequence, because according to the present application, some steps may be performed in other sequences or performed simultaneously. In addition, a person skilled in the art should also appreciate that all the embodiments described in the specification are example embodiments, and the related actions and modules are not necessarily mandatory to the present application.

In the foregoing embodiments, the description of each embodiment has respective focuses. For a part that is not described in detail in an embodiment, refer to related descriptions in other embodiments.

In the several embodiments provided in this application, it should be understood that the disclosed apparatus may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, function units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage. Based on such an understanding, the technical solutions of the present application essentially, or the part contributing to the prior art, or all or some of the technical solutions may be implemented in the form of a software product. The software product is stored in a storage and includes several instructions for instructing a computer device (which may be a personal computer, a server, or a network device) to perform all or some of the steps of the methods described in the embodiments of the present application. The foregoing storage medium includes: any medium that can store program code, such as a USB flash drive, a read-only memory (ROM), a random access memory (RAM), a removable hard disk, a magnetic disk, or an optical disc.

A person of ordinary skill in the art may understand that all or some of the steps of the methods in the embodiments may be implemented by a program instructing related hardware. The program may be stored in a computer-readable storage medium. The storage medium may include a flash memory, a read-only memory (ROM for short), a random access memory (RAM for short), a magnetic disk, and an optical disc.

The embodiments of the present application are described in detail above. The principle and implementation of the present application are described herein through specific examples. The description about the embodiments of the present application is merely provided to help understand the method and core ideas of the present application. In addition, a person of ordinary skill in the art can make variations and modifications to the present application in terms of the specific implementations and application scopes according to the ideas of the present application. Therefore, the content of specification shall not be construed as a limit to the present application.

1. A neural network search method, comprising:
obtaining a feature tensor of each of a plurality of neural networks, wherein the feature tensor of each neural network is used to represent a computing capability of the neural network;
inputting the feature tensor of each of the plurality of neural networks into an accuracy prediction model for calculation, to obtain accuracy of each neural network, wherein the accuracy of each neural network is an evaluation standard of a processing result obtained by performing task processing by using each neural network, the accuracy prediction model is obtained through training based on a ranking-based loss function, the ranking-based loss function comprises a first loss function, and the first loss function is used to measure a relationship between ranking of the accuracy of the neural networks predicted by the accuracy prediction model and ranking of real accuracy of the neural networks; and
determining a neural network corresponding to maximum accuracy as a target neural network.

2. The method according to claim 1, wherein
a larger difference between the ranking of the accuracy of the neural networks that is predicated based on the accuracy prediction model and the ranking of the real accuracy of the neural networks indicates a larger loss value obtained based on the first loss function;
a smaller difference between the ranking of the accuracy of the neural networks predicted based on the accuracy prediction model and the ranking of the real accuracy of the neural networks indicates a smaller loss value obtained based on the first loss function.

3. The method according to claim 1, wherein the ranking-based loss function is obtained by performing a linear combination on the first loss function and a second loss function, and
the second loss function is used to measure a relationship between a distance between the neural networks in a feature space and a difference between real accuracy of the neural networks.

4. The method according to claim 1, wherein the obtaining a feature tensor of each of a plurality of neural networks comprises:
obtaining a directed acyclic graph of each unit of each of the plurality of neural networks;
obtaining, based on the directed acyclic graph of each unit in each neural network, an adjacency matrix, a type vector, a runtime vector, and a parameter vector that correspond to each unit in each neural network, wherein the runtime vector is related to a hardware resource;
determining a type matrix, a runtime matrix, and a parameter matrix of each unit based on the adjacency matrix, the type vector, the runtime vector, and the parameter vector of each unit in each neural network; and
determining the tensor feature of each neural network based on the type matrix, the runtime matrix, and the parameter matrix of the unit in each neural network.

5. The method according to claim 1, wherein before the inputting the feature tensor of each of the plurality of neural networks into an accuracy prediction model for calculation, to obtain accuracy of the neural network, the method further comprises:
obtaining training data and an initial prediction model, wherein the training data comprises feature tensors of the plurality of neural networks and real accuracy corresponding to the neural networks;
inputting the feature tensors of the plurality of neural networks into the initial prediction model for calculation, to obtain a plurality of pieces of prediction accuracy;
obtaining the loss value based on the plurality of pieces of prediction accuracy, a plurality of pieces of real accuracy, and the ranking-based loss function; and
adjusting a parameter in the initial prediction model based on the loss value, to obtain the accuracy prediction model.

6. The method according to claim 1, wherein before the inputting the feature tensor of each of the plurality of neural networks into an accuracy prediction model for calculation, to obtain accuracy of the neural network, the method further comprises:
obtaining the accuracy prediction model from a training device.

7. An accuracy prediction model training method, comprising:
obtaining training data and an initial prediction model, wherein the training data comprises feature tensors of a plurality of neural networks and real accuracy corresponding to the neural networks;
inputting the feature tensors of the plurality of neural networks into the initial prediction model for calculation, to obtain a plurality of pieces of prediction accuracy;
obtaining a loss value through calculation based on the plurality of pieces of prediction accuracy, a plurality of pieces of real accuracy, and a ranking-based loss function, wherein the ranking-based loss function comprises a first loss function, and the first loss function is used to measure a relationship between ranking of accuracy that is of the neural networks and that is predicted by an accuracy prediction model and ranking of real accuracy of the neural networks; and
adjusting a parameter in the initial prediction model based on the loss value, to obtain the accuracy prediction model.

8. The method according to claim 7, wherein
a larger difference between the ranking of the accuracy of the neural networks that is predicated based on the accuracy prediction model and the ranking of the real accuracy of the neural networks indicates a larger loss value obtained based on the first loss function;
a smaller difference between the ranking of the accuracy of the neural networks predicted based on the accuracy prediction model and the ranking of the real accuracy of the neural networks indicates a smaller loss value obtained based on the first loss function.

9. The method according to claim 7, wherein the ranking-based loss function is obtained by performing a linear combination on the first loss function and a second loss function, and the second loss function is used to measure a relationship between a distance between the neural networks in a feature space and a difference between the real accuracy of the neural networks.

10. A neural network predictor, comprising:
one or more processors;
a memory coupled to the one or more processors; wherein the one or more processors comprise:
an obtaining unit, configured to obtain a feature tensor of each of a plurality of neural networks, wherein the feature tensor of each neural network is used to represent a computing capability of each neural network;
a calculating unit, configured to input the feature tensor of each of the plurality of neural networks into an accuracy prediction model for calculation, to obtain accuracy of each neural network, wherein the accuracy of each neural network is an evaluation standard of a processing result obtained by performing task processing by using each neural network, the accuracy prediction model is obtained through training based on a ranking-based loss function, the ranking-based loss function comprises a first loss function, and the first loss function is used to measure a relationship between ranking of the accuracy of the neural networks predicted by the accuracy prediction model and ranking of real accuracy of the neural networks; and
a determining unit, configured to determine a neural network corresponding to maximum accuracy as a target neural network.

11. The predictor according to claim 10, wherein
a larger difference between the ranking of the accuracy of the neural networks that is predicated based on the accuracy prediction model and the ranking of the real accuracy of the neural networks indicates a larger loss value obtained based on the first loss function;
a smaller difference between the ranking of the accuracy of the neural networks predicted based on the accuracy prediction model and the ranking of the real accuracy of the neural networks indicates a smaller loss value obtained based on the first loss function.

12. The predictor according to claim 10, wherein the ranking-based loss function is obtained by performing a linear combination on the first loss function and a second loss function, and
the second loss function is used to measure a relationship between a distance between the neural networks in a feature space and a difference between real accuracy of the neural networks.

13. The predictor according to claim 10, wherein the obtaining unit is configured to:
obtain a directed acyclic graph of each unit of each of the plurality of neural networks;
obtain, based on the directed acyclic graph of each unit in each neural network, an adjacency matrix, a type vector, a runtime vector, and a parameter vector that are corresponding to each unit in each neural network, wherein the runtime vector is related to a hardware resource;
determine a type matrix, a runtime matrix, and a parameter matrix of each unit based on the adjacency matrix, the type vector, the runtime vector, and the parameter vector of each unit in each neural network; and
determine the tensor feature of each neural network based on the type matrix, the runtime matrix, and the parameter matrix of the unit in each neural network.

14. The predictor according to claim 10, wherein the obtaining unit is further configured to:
before the calculating unit inputs the feature tensor of each of the plurality of neural networks into the accuracy prediction model for calculation, to obtain the accuracy of the neural networks, obtain the accuracy prediction model, wherein
in an aspect of obtaining the accuracy prediction model, the obtaining unit is configured to:
obtain training data and an initial prediction model, wherein the training data comprises feature tensors of the plurality of neural networks and real accuracy corresponding to the neural networks;
input the feature tensors of the plurality of neural networks into the initial prediction model for calculation, to obtain a plurality of pieces of prediction accuracy;
obtain the loss value based on the plurality of pieces of prediction accuracy, a plurality of pieces of real accuracy, and the ranking-based loss function; and
adjust a parameter in the initial prediction model based on the loss value, to obtain the accuracy prediction model.

15. The predictor according to claim 8, wherein the obtaining unit is further configured to: before the calculating unit inputs the feature tensor of each of the plurality of neural networks into the accuracy prediction model for calculation, to obtain the accuracy of the neural networks, obtain the accuracy prediction model from a training device.

16. A training device, comprising:
one or more processors;
a memory coupled to the one or more processors, wherein the one or more processors comprise:
an obtaining unit, configured to obtain training data and an initial prediction model, wherein the training data comprises feature tensors of a plurality of neural networks and real accuracy corresponding to the neural networks;
a calculating unit, configured to input the feature tensors of the plurality of neural networks into the initial prediction model for calculation, to obtain a plurality of pieces of prediction accuracy; and obtain a loss value through calculation based on the plurality of pieces of prediction accuracy, a plurality of pieces of real accuracy, and a ranking-based loss function, wherein the ranking-based loss function comprises a first loss function, and the first loss function is used to measure a relationship between ranking of accuracy that is of the neural networks and that is predicted by the accuracy prediction model and ranking of real accuracy of the neural networks; and
an adjusting unit, configured to adjust a parameter in the initial prediction model based on the loss value, to obtain the accuracy prediction model.

17. The training device according to claim 16, wherein
a larger difference between the ranking of the accuracy of the neural networks that is predicated based on the accuracy prediction model and the ranking of the real accuracy of the neural networks indicates a larger loss value obtained based on the first loss function;
a smaller difference between the ranking of the accuracy of the neural networks predicted based on the accuracy prediction model and the ranking of the real accuracy of the neural networks indicates a smaller loss value obtained based on the first loss function.

18. The training device according to claim 16, wherein the ranking-based loss function is obtained by performing a linear combination on the first loss function and a second loss function, and the second loss function is used to measure a relationship between a distance between the neural networks in a feature space and a difference between the real accuracy of the neural networks.

19. (canceled)

20. (canceled)

21. A non-transitory computer-readable storage medium, wherein the computer-readable storage medium stores a computer program, and when the computer program is executed by a processor, the method according to claim 1 is implemented.
